(19) United States
(12) Patent Application Publication
(10) Pub. No.: US 2025/0059328 A1
(43) Pub. Date: Feb. 20, 2025

(54) Curable Precursor of an Adhesive Composition

(71) Applicant: 3M INNOVATIVE PROPERTIES COMPANY, St. Paul, MN (US)

(72) Inventors: Ralph R. Roberts, Oakdale, MN (US); Rajdeep S. Kalgutkar, Woodbury, MN (US)

(21) Appl. No.: 18/718,503

(22) PCT Filed: Dec. 7, 2022
(86) PCT No.: PCT/IB2022/061903

§ 371 Date: Jun. 11, 2024

Related U.S. Application Data
(60) Provisional application No. 63/289,529, filed on Dec. 14, 2021.

(51) Int. Cl. C08G 73/14; C08G 73/12; C09J 179/08

(52) U.S. Cl. CPC C08G 73/14; C08G 73/128; C09J 179/085; C08G 2170/00

(57) ABSTRACT

The present disclosure relates to a curable precursor of an adhesive composition, the curable precursor comprising a maleimide-terminated polyamide-imide polymer. The present disclosure further relates to an adhesive composition comprising a cured adhesive, wherein the cured adhesive is the reaction product of said curable precursor, and to a process for making said curable precursor of an adhesive composition, the process comprising reacting an amine-terminated polyamide with a bis-maleimide by a poly-Michael-Addition.

### TECHNICAL FIELD

The present disclosure relates to a curable precursor of an adhesive composition comprising a maleimide-terminated polyamide-imide polymer.

### BACKGROUND

Curable compositions have been known for years as suitable for use in a variety of applications that include general-use industrial applications such as adhesives and coatings, as well as high-performance applications in the electronics industry such as, e.g., for sealing and bonding electronic components. With broadened use of curable compositions over the years, performance requirements have become more and more demanding with respect to, in particular, curing profile, adhesion performance, storage stability, handleability and processability characteristics, and compliance with environment and health requirements. When curable compositions are additionally required to provide thermal stability, the formulation of suitable compositions becomes even more challenging.

For semiconductor packaging, for processes such as fan-out wafer level packaging (FOWLP) and fan-out panel-level packaging (FOPLP), temporary bonding adhesives are required to withstand higher temperatures. These processes include the direct chemical vapor deposition (CVD) of copper seed layers onto the temporary bonding adhesive layer. Desirable properties of the adhesive include controlled adhesion after the fabrication process allowing for removal without contamination or damage to the fabricated part, and a coefficient of thermal expansion (CTE) matching with the contacting surface so as to prevent warpage of the processed reconstituted wafer.

US 2004/0225026 A1 discloses adhesive compositions comprising imide-extended maleimides and polymaleimides. The maleimide units in the imide-extended maleimides and polymaleimides are linked by a substituted or unsubstituted aliphatic, aromatic, heteroaromatic or siloxane moiety.

US 2011/0152466 A1 discloses a method for amide-extending an ethylenically unsaturated monomer, oligomer or polymer, comprising reacting the ethylenically unsaturated monomer, oligomer or polymer with a primary amine via a Michael addition reaction and acylating the formed amine-terminated intermediate to form an amine-extended monomer, oligomer or polymer. The ethylenically unsaturated monomer, oligomer or polymer may be a bismaleimide. In the obtained amine-extended monomer, oligomer or polymer, the two nitrogen atoms of the originating bismaledimide are linked by a substituted or unsubstituted aliphatic, cycloaliphatic, alkenyl, aryl, heteroaryl, polydimethylsiloxane, poly(butadiene-co-acrylonitrile) or a poly(alkylene oxide)-derived moiety.

There is still a need for a curable precursor of an adhesive composition having a good high temperature stability and being usable as temporary bonding adhesive.

As used herein, “a”, “an”, “the”, “at least one” and “one or more” are used interchangeably. The term “comprise” shall include also the terms “consist essentially of” and “consists of”.

### SUMMARY

In a first aspect, the present disclosure relates to a curable precursor of an adhesive composition, the curable precursor comprising a maleimide-terminated polyamide-imide polymer.

In another aspect, the present disclosure also relates to an adhesive composition comprising a cured adhesive, wherein the cured adhesive is the reaction product of the curable precursor disclosed herein.

In yet a further aspect, the present disclosure relates to a process for making a curable precursor of an adhesive composition as disclosed herein, the process comprising reacting an amine-terminated polyamide with a bis-maleimide by a poly-Michael-Addition.

In yet a further aspect, the present disclosure relates to an article comprising a first substrate, a second substrate and an adhesive composition disposed between and adhering to the first substrate and the second substrate, wherein the adhesive composition is according to the present disclosure.

In yet a further aspect, the present disclosure relates to an article comprising an adhesive composition according to the present disclosure, a first substrate and a cover film, wherein the adhesive composition is disposed between and adhering to the first substrate and the cover film, and wherein the adhesion to the cover film is lower than the adhesion to the first substrate, and wherein the cover film is a temporary protective layer.

In yet a further aspect, the present disclosure relates to a method of use of an adhesive composition according to the present disclosure, comprising
disposing the adhesive composition between a first substrate and a second substrate and adhering the first substrate to the second substrate by the adhesive composition, wherein the second substrate comprises a plurality of individual elements;
conducting one or more process steps on the individual elements, wherein the plurality of individual elements is combined by the one or more process steps; and
removing the first substrate and the adhesive composition from the second substrate.

In yet a further aspect, the present disclosure relates to a method of use of a curable precursor according to the present disclosure, the method comprising
disposing the curable precursor between a first substrate and a second substrate and contacting the first and the second substrate by the curable precursor;
curing the curable precursor to form an adhesive composition adhering the first substrate to the second substrate.

The curable precursor of an adhesive composition as disclosed herein has a good high temperature stability.

The curable precursor of an adhesive composition as disclosed herein is usable as temporary bonding adhesive.

### DETAILED DESCRIPTION

Disclosed herein is a curable precursor of an adhesive composition. The curable precursor comprises a maleimide-terminated polyamide-imide polymer.

A “curable precursor” is meant to designate a composition which can be cured by crosslinking of the maleimide-terminated polyamide-imide polymer.

The terms “cure” and “curable” refer to joining polymer chains together by covalent chemical bonds, usually via crosslinking molecules or groups, to form a network polymer. Therefore, in this disclosure the terms “cured” and “crosslinked” may be used interchangeably.

A “maleimide-terminated polyamide imide polymer” is meant to designate a polyamide imide polymer having maleimide end groups.

The maleimide-terminated polyamide-imide polymer of the curable precursor disclosed herein may be according to formula (6)

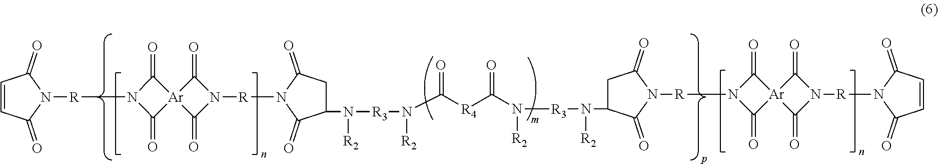

wherein
n is an integer from 0 to 10;
m is an integer from 1 to 15, preferably from 1 to 5;
p is an integer from 1 to 20;
R is an aliphatic or aromatic moiety;
Ar is a tetravalent aromatic moiety;
R₃ is an alkylene, branched alkylene, cycloalkylene, substituted or unsubstituted arylene, heteroalkylene, heterocycloalkylene, or silicone group;
R₄ is an aliphatic or aromatic moiety;
and for each —R₂N—R₃—NR₂— unit in formula (6)
   (i) each of the two R₂ groups, independently, is hydrogen or a linear or branched alkyl, cycloalkyl, aryl, heteroalkyl, or heteroaryl moiety, or
   (ii) the two R₂ groups are alkylene or branched alkylene and form a heterocyclic compound.

In formula (6), R is an aliphatic or aromatic moiety. As used herein, the term “aliphatic” refers to C1-C40, suitably C1-C30, straight or branched chain alkenyl, alkyl, or alkynyl which may or may not be interrupted or substituted by one or more heteroatoms such as O, N, or S. As used herein, the term “aromatic” refers to C3-C40, suitably C3-C30, aromatic groups including both carbocyclic aromatic groups as well as heterocyclic aromatic groups containing one or more of the heteroatoms O, N, or S, and fused ring systems containing one or more of these aromatic groups fused together.

In formula (6), Ar is a tetravalent aromatic moiety.

In formula (6), R₃ is an alkylene, branched alkylene, cycloalkylene, substituted or unsubstituted arylene, heteroalkylene, heterocycloalkylene, or silicone group. The term “alkylene” refers to a divalent group that is a radical of an alkane. Unless otherwise indicated, the alkylene group typically has 1 to 30 carbon atoms. In some embodiments, the alkylene group has 1 to 20 carbon atoms, 1 to 10 carbon atoms, 1 to 6 carbon atoms, or 1 to 4 carbon atoms. Examples of alkylene groups include methylene, ethylene, 1,3-propylene (—CH2CH2CH2-), and 1,4-butylene. An example for a branched alkylene group is 1,2-propylene (—CH2CH(Me)CH2- with Me being methyl). Examples for cycloalkylene groups are 1,4-cyclohexylene, and 1,4-cyclo-hexyldimethylene. An example for a heteroalkylene group is —CH2CH2-O—CH2CH2- or any other Jeffamine. An example for a heterocycloalkylene group is —CH2-furan ring-CH2-. The term “arylene” refers to a divalent group that is aromatic and, optionally, carbocyclic. The arylene has at least one aromatic ring. Optionally, the aromatic ring can have one or more additional carbocyclic rings that are fused to the aromatic ring. Any additional rings can be unsaturated, partially saturated, or saturated. Unless otherwise indicated, arylene groups often have 6 to 20 carbon atoms, 6 to 18 carbon atoms, 6 to 16 carbon atoms, 6 to 12 carbon atoms, or 6 to 10 carbon atoms. An example for a substituted or unsubstituted arylene group is -1,4-Phenylene-.

In formula (6), the group R₄ may be an aliphatic or aromatic moiety. As used herein, the term “aliphatic” refers to C3-C30 straight or branched chain alkenyl, alkyl, or alkynyl which may or may not be interrupted or substituted by one or more heteroatoms such as O, N, or S. In some embodiments, the group R₄ is derived from a dicarboxylic dimer acid and may contain 12 to 100 carbon atoms. The term “aromatic” refers to C3-C40, suitably C3-C30, aromatic groups including both carbocyclic aromatic groups as well as heterocyclic aromatic groups containing one or more of the heteroatoms O, N, or S, and fused ring systems containing one or more of these aromatic groups fused together. In some embodiments, the group R₄ is a moiety derived from a dicarboxylic dimer acid, which means that R₄ in formula (6) is a dimer acid without the dicarboxylic (—COOH) moieties. In some preferred embodiments, the group R₄ is a moiety derived from a dicarboxylic C-36 dimer acid, which means that R₄ in formula (6) is a C-36 dimer acid without the dicarboxylic (—COOH) moieties. i.e. a C₃₄Hₓ group.

For each —R₂N—R₃—NR₂— unit in formula (6)
(i) each of the two R₂ groups, independently, is hydrogen or a linear or branched alkyl, cycloalkyl, aryl, heteroalkyl, or heteroaryl moiety, or
(ii) the two R₂ groups are alkylene or branched alkylene and form a heterocyclic compound.

The term “alkyl” refers to a monovalent group that is a radical of an alkane including both unsubstituted and substituted alkyl groups. The alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of “alkyl” groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, norbornyl, and the like.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms. In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, and anthracyl.

An example for a heteroalkyl group is —CH2CH2-O—CH3. An example for a heteroaryl group is -2-substituted-pyridyl. An example for the two R₂ groups being alkylene or branched alkylene and forming a heterocyclic compound is piperazine.

In some embodiments, the two R₂ groups of one or more individual —R₂N—R₃—NR₂— units in formula (6) are both hydrogen. Preferably, the two R₂ groups of the individual —R₂N—R₃—NR₂— units are both a linear or branched alkyl group, or the two R₂ groups of the individual —R₂N—R₃—NR₂— units are both an alkylene or a branched alkylene group and form a heterocyclic compound. Combinations of these two are also possible, i.e. the two R₂ groups of some of the individual —R₂N—R₃—NR₂— units may be both a linear or branched alkyl group, and the two R₂ groups of some other the individual —R₂N—R₃—NR₂— units may be both an alkylene or a branched alkylene group and form a heterocyclic compound.

The maleimide-terminated polyamide-imide polymer of the curable precursor is a reaction product of (i) an amine-terminated polyamide and (ii) a bis-maleimide.

The amine-terminated polyamide which is used for the reaction to make the maleimide-terminated polyamide-imide polymer may comprise tertiary amides in the backbone of the amine-terminated polyamide. For each tertiary amide in the backbone of the amine-terminated polyamide, the corresponding R₂ of the —R₂N—CO— unit in the resulting maleimide-terminated polyamide-imide polymer according to formula (6) is not hydrogen.

As used herein, the term “backbone” refers to the main continuous chain of the polymer.

In the amine-terminated polyamide, tertiary amides may be present in an amount of at least 50 mol %, based on the total amide content present in the backbone of the amine-terminated polyamide. In some embodiments, the tertiary amides may be present in the backbone of the amine-terminated polyamide in an amount of at least 70 mol %, at least 90 mol %, at least 95 mol %, or at least 99 mol 00 based on the total amide content present in the backbone of the amine-terminated polyamide.

In some embodiments, tertiary amides may be present in the backbone of the amine-terminated polyamide in an amount of 50-100 mol %, 70-100 mol %, 90-100 mol %, 50-99 mol %, 70-99 mol %, 90-99 mol %, 95-100 mol %, 95-99 mol %, or 99-100 mol %, based on the total amide content present in the backbone of the amine-terminated polyamide.

Generally, it is believed that the presence of such tertiary amides enhances elongation at break at room temperature by reducing the volume density of hydrogen bonding and crosslinking, while maintaining good adhesion to metallic substrates.

In the amine-terminated polyamide, in addition to the tertiary amides, secondary amides may be included in the backbone thereof.

In some embodiments, the amine-terminated polyamide may be liquid (e.g., a viscous liquid having a viscosity of about 500-50,000 cP) at room temperature.

The amine-terminated polyamide which is used for the reaction to make the maleimide-terminated polyamide-imide polymer is according to formula (1)

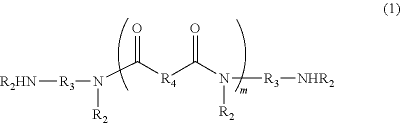

wherein
m is an integer from 1 to 15, preferably from 1 to 5;
R₃ is an alkylene, branched alkylene, cycloalkylene, substituted or unsubstituted arylene, heteroalkylene, heterocycloalkylene, or silicone group;
R₄ is an aliphatic or aromatic moiety;
and for each —R₂N—R₃—NR₂ unit in formula (1)
   (i) each R₂ group, independently, is hydrogen or a linear or branched alkyl, cycloalkyl, aryl, heteroalkyl, or heteroaryl moiety, or
   (ii) the two R₂ groups are linear or branched alkyl and form a heterocyclic compound.

In formula (1), the group R₃ is an alkylene, branched alkylene, cycloalkylene, substituted or unsubstituted arylene, heteroalkylene, heterocycloalkylene, or silicone group. The alkylene, branched alkylene, cycloalkylene, substituted and unsubstituted arylene, heteroalkylene, heterocycloalkylene, and silicone group and examples thereof are as described above in more detail for formula (6).

In formula (1), the group R₄ is an aliphatic or aromatic moiety. The aliphatic and aromatic moiety is as described above in more detail for formula (6).

For embodiments with the amine-terminated polyamide being derived from a C-36 dimer acid (C₃₄Hₓ—(COOH)₂), with reference to formulas (1) and (6), the group R₄ is a C₃₄ moiety.

For each —R₂N—R₃—NR₂ unit in formula (1)
(i) each R₂ group, independently, is hydrogen or a linear or branched alkyl, cycloalkyl, aryl, heteroalkyl, or heteroaryl moiety, or
(ii) the two R₂ groups are linear or branched alkyl and form a heterocyclic compound.

The linear or branched alkyl, cycloalkyl, aryl, heteroalkyl, heteroaryl moiety, and heterocyclic compound of the R₂ group are as described above in more detail for formula (6).

In some embodiments, the two R₂ groups of one or both —R₂N—R₃—NR₂ units in formula (1) are both hydrogen. Preferably, the two R₂ groups of each —R₂N—R₃—NR₂ unit are both a linear or branched alkyl group, or the two R₂ groups of each —R₂N—R₃—NR₂ unit are both a linear or branched alkyl group and form a heterocyclic compound. Combinations of these two are also possible, i.e., the two R₂ groups of one of the two —R₂N—R₃—NR₂ units may be both a linear or branched alkyl group, and the two R₂ groups of the other one of the two —R₂N—R₃—NR₂ units may be both a linear or a branched alkyl group and form a heterocyclic compound.

The bis-maleimide which is used for the reaction to make the maleimide-terminated polyamide-imide polymer is according to formula (5)

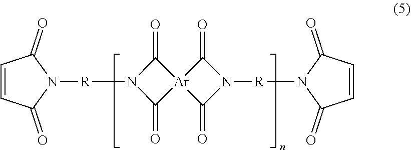

wherein
n is an integer from 0 to 10;
R is an aliphatic or aromatic moiety; and
Ar is a tetravalent aromatic moiety.

In formula (5), the aromatic moiety R also includes an alkyl arylene, or a phenylene ether moiety.

In some embodiments, the bis-maleimide comprises an aromatic bis-maleimide. An “aromatic bis-maleimide” is a bis-maleimide with R in formula (5) being an aromatic moiety. The aromatic moiety R may include an alkyl arylene, or a phenylene ether moiety. In some embodiments, the bis-maleimide comprises a bis-maleimide derived from a dimer diamine, preferably from a C-36 dimer diamine, i.e. R in formula (5) is derived from a dimer diamine, preferably from a C-36 dimer diamine. The C-36 moiety of the bis-maleimide derived from a C-36 dimer diamine can be fully saturated (˜C36H72˜) or can be unsaturated (˜C36H70˜). The bis-maleimide may also comprise a combination of both, i.e., the bis-maleimide may comprise an aromatic bis-maleimide and a bis-maleimide derived from a dimer diamine, preferably from a C-36 dimer diamine.

A dimer diamine can be obtained from a dimer acid by reaction with ammonia and subsequent reduction.

For the dimer diamine, dimer acids may be used as explained herein in more detail for the dicarboxylic acids which may be used for the reaction to form the amine-terminated polyamide.

An example of an aromatic bis-maleimide is 1,1′-(methylenebis(4,1-phenylene))bis(1H-pyrrole-2,5-dione), which has the following formula

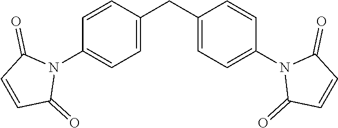 [SMILES: O=C1C=CC(=O)N1c1ccc(Cc2ccc(N3C(=O)C=CC3=O)cc2)cc1]

and which is a bis-maleimide with a value of n=zero (0) and R being a 1,1′-(methylenebis(4,1-phenylene) moiety in formula (5).

Examples for bis-maleimides derived from a C-36 dimer diamine are BMI-689, BMI-1400 and BMI-3000, available from Designer Molecules Inc, San Diego, CA, USA.

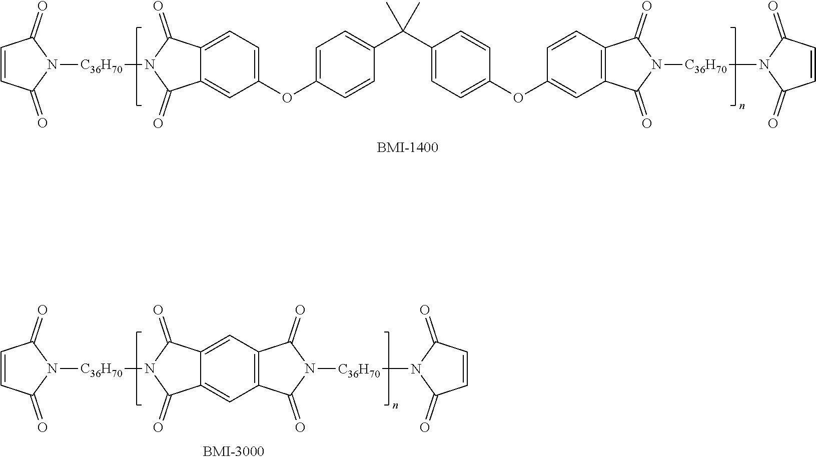

For embodiments with the bis-maleimide being derived from a dimer diamine, with reference to formulas (1) and (5), the group R is derived from a dimer diamine, preferably from a C-36 dimer diamine, i.e., R is a C-36 dimer acid with —N—H2 moieties instead of carboxylic (—COOH) moieties.

The amine-terminated polyamide which is used for the reaction to make the maleimide-terminated polyamide-imide polymer is a reaction product of (i) a diamine, and (ii) a compound selected from the group consisting of dicarboxylic acids, dicarboxylic acid derivatives, and combinations thereof. The reaction by which the amine-terminated polyamide is synthesized is a poly-condensation reaction.

The diamine which is used for the reaction to make the amine-terminated polyamide is selected from the group consisting of secondary diamines, secondary/primary hybrid diamines, and mixtures thereof.

In some embodiments, the diamine may include one or more secondary diamines or one or more secondary/primary hybrid diamines, and, optionally, one or more primary diamines.

The diamine which is used for the reaction to make the amine-terminated polyamide may have a formula R₂—NH—R₃—NH—R₂, wherein the R₃ group is an alkylene or branched alkylene group, cycloalkylene group, substituted or unsubstituted arylene group, heteroalkylene group, heterocycloalkylene group, or silicone group,
and wherein
   (i) each R₂ group, independently, is a linear or branched alkyl group, cycloalkyl group, aryl group, heteroalkyl group, heteroaryl group, or hydrogen atom, or
   (ii) the R₂ groups are linear or branched alkyl and form a heterocyclic compound.

The alkylene, branched alkylene, cycloalkylene, substituted or unsubstituted arylene, heteroalkylene, heterocycloalkylene, or silicone group of the R₃ group and examples thereof are as described above in more detail for formula (6).

The linear or branched alkyl, cycloalkyl, aryl, heteroalkyl, heteroaryl moiety, and heterocyclic compound of the R₂ group are as described above in more detail for formula (6).

Suitable secondary diamines may include, for example, piperazine, 1,3-Di-4-piperidylpropane, cyclohexanamine, 4,4′-methylenebis[N-(1-methylpropyl). In some embodiments, suitable secondary/primary hybrid diamines (i.e., diamines having a secondary amine and a primary amine) include, for example, aminoethyl piperazine. In some embodiments, the secondary/primary hybrid diamines may not be present, or may be present in an amount of less than 50 mol. %, less than 30 mol. 00 less than 10 mol. %, or less than 5 mol. %, based on the total moles of the secondary or secondary/primary hybrid diamines. In some embodiments, the number average molecular weight of suitable secondary diamines or secondary/primary hybrid diamines may be from 30 g/mol to 5000 g/mol, 30 g/mol to 500 g/mol, or 50 g/mol to 100 g/mol.

In some embodiments, the secondary diamines or secondary/primary hybrid diamines, alone or in combination, may be used in the diamine in an amount of from 50-100 mol %, 70-100 mol %, 90-100 mol %, 50-99 mol %, 70-99 mol %, 90-99 mol %, 95-100 mol %, 95-99 mol %, or 99-100 mol %, based on the total moles of the diamine which is used for the reaction to make the amine-terminated polyamide.

In some embodiments, the two R₂ groups of one or both —R₂N—R₃—NR₂ units in formula (1) are both hydrogen. Preferably, the two R₂ groups of each —R₂N—R₃—NR₂ unit are both a linear or branched alkyl group, or the two R₂ groups of each —R₂N—R₃—NR₂ unit are both a linear or branched alkyl group and form a heterocyclic compound. Combinations of these two are also possible, i.e., the two R₂ groups of one of the two —R₂N—R₃—NR₂ units may be both a linear or branched alkyl group, and the two R₂ groups of the other one of the two —R₂N—R₃—NR₂ units may be both a linear or a branched alkyl group and form a heterocyclic compound.

Primary diamines, i.e., diamines with both of the two R₂ groups being hydrogen, may be utilized in addition to the secondary diamines or secondary/primary hybrid diamines, in an amount not exceeding 50 mole percent, based on the total amount of diamines which are used for the reaction to make the amine-terminated polyamide. Exemplary primary diamines are primary aliphatic diamines such as ethylenediamine and 1,2-propylenediamine. In some embodiments, the number average molecular weight of suitable primary diamines may be from 30 g/mol to 5000 g/mol, 30 g/mol to 500 g/mol, or 50 g/mol to 100 g/mol.

In some embodiments, primary amines may not be present in the diamine, or may be present in the diamine in an amount of between 1-10 mol % or 1-5 mol %, based on the total moles of the diamine which is used for the reaction to make the amine-terminated polyamide.

Preferably, the two R₂ groups of the diamine are both a linear or branched alkyl group, or the two R₂ groups of the diamine are both a linear or branched alkyl group and form a heterocyclic compound.

Preferably, the diamine that may be used for the reaction to make the amine-terminated polyamide comprises the secondary diamines piperazine (2)

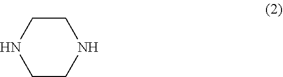

or 1,3-di(piperidin-4-yl)propane (3)

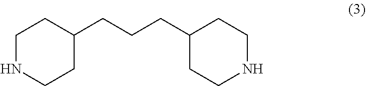 [SMILES: C(CC1CCNCC1)CC1CCNCC1]

or combinations thereof.

The diamine may optionally further comprise a secondary amine-terminated silicone according to formula (4)

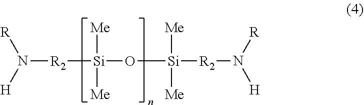

wherein
n is an integer from 5-40;
R is a C₁-C₆ linear or branched alkyl group; [
R₂ is a C₃ alkyl or substituted alkyl group;
Me is a methyl or phenyl group.
   R in formula (4) corresponds to R₂ in formulas (1) and (6) and in the formula for the diamine R₂—NH—R₃—NH—R₂ which is used for the reaction to make the amine-terminated polyamide.
   R₂ in formula (4) does not correspond to the R₂ of formulas (1) and (6) and in the formula for the diamine R₂—NH—R₃—NH—R₂ which is used for the reaction to make the amine-terminated polyamide.

For the secondary amine-terminated silicone according to formula (4), the group R₃ in formulas (6) and (1) and in the diamine formula R₂—NH—R₃—NH—R₂ as described above is a silicone group according to the formula

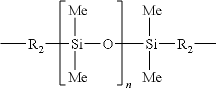

wherein n, R₂ and Me are defined as above for formula (4).

An example for a secondary amine-terminated silicone is N-ethylaminoisobutyl terminated polydimethylsiloxane having the formula

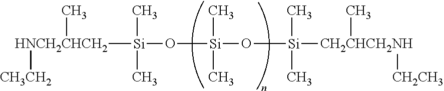

wherein n is an integer from 5 to 40.

N-ethylaminoisobutyl terminated polydimethylsiloxane is available from Gelest, Inc., Morrisville, Pennsylvania, USA under the trade designation DMS-A211 and DMS-A214.

The amount of secondary amine-terminated silicones may be up to 30 mole percent, based on the total amount of diamines which are used for the reaction to make the amine-terminated polyamide. Typically, at least 1 mole percent or at least 2 mole percent of secondary amine-terminated silicones are used, based on the total amount of diamines which are used for the reaction to make the amine-terminated polyamide. Preferably, from 2 to 30 mole percent of secondary amine-terminated silicones may be used, based on the total amount of diamines which are used for the reaction to make the amine-terminated polyamide.

The diamine according to formula (4) may be used to affect the tack of the curable precursor and the release properties of the cured adhesive. If more than 30 mole percent of secondary amine-terminated silicones are used, the adhesive properties of the curable precursor might be adversely affected, and the diamine comprising more than 30 mole percent of secondary amine-terminated silicones might not react with the dicarboxylic acid or dicarboxylic acid derivative to form the amine-terminated polyamide.

In some embodiments of the curable precursor, the diamine which is used for the reaction to form the amine-terminated polyamide is free of aryl moiety, i.e., the groups R₂ and R₃ in the diamine formula R₂—NH—R₃—NH—R₂ as described above and in formulas (6) and (1) are not an aryl or arylene group, respectively.

In some embodiments, the dicarboxylic acid which is used for the reaction to form the amine-terminated polyamide may include at least one alkyl or alkenyl group and may contain 3 to 30 carbon atoms and may be characterized by having two carboxylic acid groups. The alkyl or alkenyl group may be branched. The alkyl group may be cyclic. Useful dicarboxylic acids may include propanedioic acid, butanedioic acid, pentanedioic acid, hexanedioic acid, heptanedioic acid, octanedioic acid, nonanedioic acid, decanedioic acid, undecanedioic acid, dodecanedioic acid, hexadedanedioic acid, (Z)-butenedioic acid, (E)-butenedioic acid, pent-2-enedioic acid, dodec-2-enedioic acid, (2Z)-2-methylbut-2-enedioic acid, (2E,4E)-hexa-2,4-dienedioic acid, and sebacic acid. Aromatic dicarboxylic acids may be used, such as phthalic acid, isophthalic acid, terephthalic acid and 2,6-napththalenedicarboxylic acid. Mixtures of two or more dicarboxylic acids may be used, as mixtures of different dicarboxylic acids may aid din disrupting the structural regularity of the polyamide, thereby significantly reducing or eliminating crystallinity in the resulting polyamide component.

In some embodiments, the dicarboxylic acid which is used for the reaction to form the amine-terminated polyamide is a dicarboxylic dimer acid, also referred to as dimer acid. If a dimer acid is used as a dicarboxylic acid to form the amine-terminated polyamide, the group R₄ in formulas (6) and (1) is a moiety derived from a dicarboxylic dimer acid, which means that R₄ in formulas (6) and (1) is a dimer acid without the dicarboxylic (—COOH) moieties.

In some embodiments, the dicarboxylic dimer acid may include at least one alkyl or alkenyl group and may contain 12 to 100 carbon atoms, 16 to 100 carbon atoms, or 18 to 100 carbon atoms and is characterized by having two carboxylic acid groups. The dimer acid may be saturated or partially unsaturated. In some embodiments, the dimer acid may be a dimer of a fatty acid. The phrase “fatty acid”, as used herein means an organic compound composed of an alkyl or alkenyl group containing 5 to 22 carbon atoms and characterized by a terminal carboxylic acid group. Useful fatty acids are disclosed in “Fatty acids in Industry: Processes, Properties, Derivatives, Applications”, Chapter 7, pp 153-175, Marcel Dekker, Inc., 1989. In some embodiments, the dimer acid may be formed by the dimerization of unsaturated fatty acids having 18 carbon atoms such as oleic acid or tall oil fatty acid. The dimer acids are often at least partially unsaturated and often contain 36 carbon atoms. The dimer acids may be relatively high molecular weight and made up of mixtures comprising various ratios of a variety of large or relatively high molecular weight substituted cyclohexenecarboxylic acids, predominantly 36-carbon dicarboxylic dimer acid. Structures of the dimer acids may by acyclic, cyclic (monocyclic or bicyclic) or aromatic, as shown below.

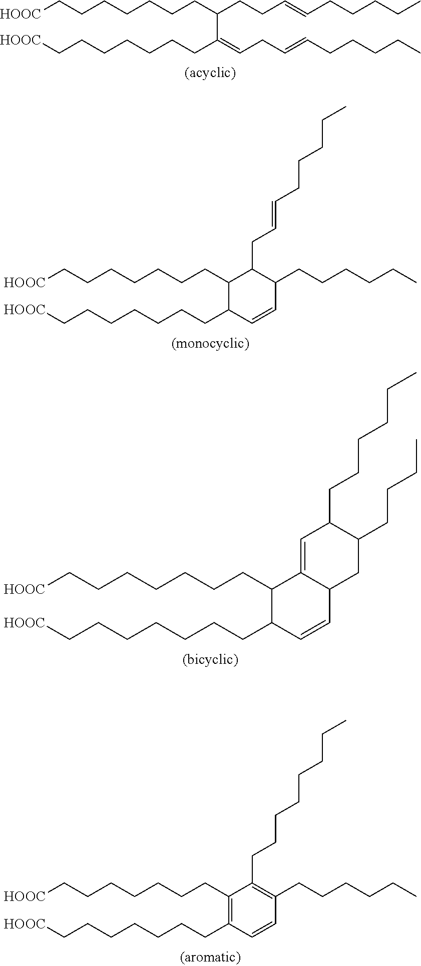 [SMILES: CCCCC/C=C/C/C=C(/CCCCCCCC(=O)O)C(CC/C=C/CCCCC)CCCCCCCC(=O)O ; CCCCC/C=C/CC1C(CCCCCC)C=CC(CCCCCCCC(=O)O)C1CCCCCCCC(=O)O ; CCCCCCC1C=C2C(C=CC(CCCCCCCC(=O)O)C2CCCCCCCC(=O)O)CC1CCCC ; CCCCCCCCc1c(CCCCCC)ccc(CCCCCCCC(=O)O)c1CCCCCCCC(=O)O]

The dimer acids may be prepared by condensing unsaturated monofunctional carboxylic acids such as oleic, linoleic, soya or tall oil acid through their olefinically unsaturated groups, in the presence of catalysts such as acidic clays. The distribution of the various structures in dimer acids (nominally C36 dibasic acids) depends upon the unsaturated acid used in their manufacture. Typically, oleic acid gives a dicarboxylic dimer acid containing about 38% acyclics, about 56% mono- and bicyclics, and about 6% aromatics. Soya acid gives a dicarboxylic dimer acid containing about 24% acyclics, about 58% mono- and bicyclics and about 18% aromatics. Tall oil acid gives a dicarboxylic dimer acid containing about 13% acyclics, about 75% mono- and bicyclics and about 12% aromatics. The dimerization procedure also produces trimer acids. The commercial dimer acid products are typically purified by distillation to produce a range of dicarboxylic acid content. Useful dimer acids contain at least 80% dicarboxylic acid, more preferably 90% dicarboxylic acid content, even more preferably at least 95% dicarboxylic acid content. For certain applications, it may be advantageous to further purify the dimer acid by color reduction techniques including hydrogenation of the unsaturation, as disclosed in U.S. Pat. No. 3,595,887. Hydrogenated dimer acids may also provide increased oxidative stability at elevated temperatures. Other useful dimer acids are disclosed in Kirk-Othmer Encyclopedia of Chemical Technology, Organic Chemicals: Dimer Acids (ISBN 9780471238966), copyright 1999-2014, John Wiley and Sons, Inc. Commercially available dicarboxylic dimer acids are available under the trade designation EMPOL 1008 and EMPOL 1061 both from BASF, Florham Park, New Jersey, and PRIPOL 1006, PRIPOL 1009, PRIPOL 1013, PRIPOL 1017, and PRIPOL 1025 all from Croda Inc., Edison, New Jersey, for example.

In some embodiments, the number average molecular weight of the dicarboxylic dimer acid may be between from 300 g/mol to 1400 g/mol, between from 300 g/mol to 1200 g/mol, between from 300 g/mol to 1000 g/mol, or even between from 300 g/mol to 800 g/mol. In some embodiments, the number of carbon atoms in the dicarboxylic dimer acid may be between from 12 to 100, between from 20 to 100, between from 30 to 100, between from 12 to 80, between from 20 to 80, between from 30 to 80, between from 12 to 60, between from 20 to 60 or even between from 30 to 60. In some embodiments, the mole fraction of dicarboxylic dimer acid included as the dicarboxylic acid is between from 0.10 to 1.00, based on the total moles of dicarboxylic acid used to form the amine-terminated polyamide. In some embodiments, the mole fraction of dicarboxylic dimer acid included as the dicarboxylic acid, is between from 0.30 to 1.00, between from 0.50 to 1.00, between from 0.70 to 1.00, between from 0.80 to 1.00, between from 0.90 to 1.00, between from 0.10 to 0.98, between from 0.30 to 0.98, between from 0.50 to 0.98, between from 0.70 to 0.98, between from 0.80 to 0.98, or even between from 0.90 to 0.98, based on the total moles of dicarboxylic acid used to form the amine-terminated polyamide. In some embodiments, the mole fraction of dicarboxylic dimer acid included as the dicarboxylic acid is 1.00, based on the total moles of dicarboxylic acid used to form the amine-terminated polyamide. Mixtures of two or more dimer acids may be used.

Preferably, a C-36 dimer acid is used as dicarboxylic acid for the reaction to form the amine-terminated polyamide.

If a C-36 dimer acid is used as a dicarboxylic acid to form the amine-terminated polyamide, the group R₄ in formulas (6) and (1) is a moiety derived from a dicarboxylic C-36 dimer acid, which means that R₄ in formulas (6) and (1) is a dimer acid without the dicarboxylic (—COOH) moieties, i.e., a C₃₄Hₓ group.

Examples for dicarboxylic acid derivatives are dicarboxylic acid anhydrides and dicarboxylic acid chloride esters.

The dicarboxylic acid anhydrides and dicarboxylic acid chloride esters may be derived from the exemplary dicarboxylic acids explained above in more detail.

Exemplary dicarboxylic acid anhydrides are

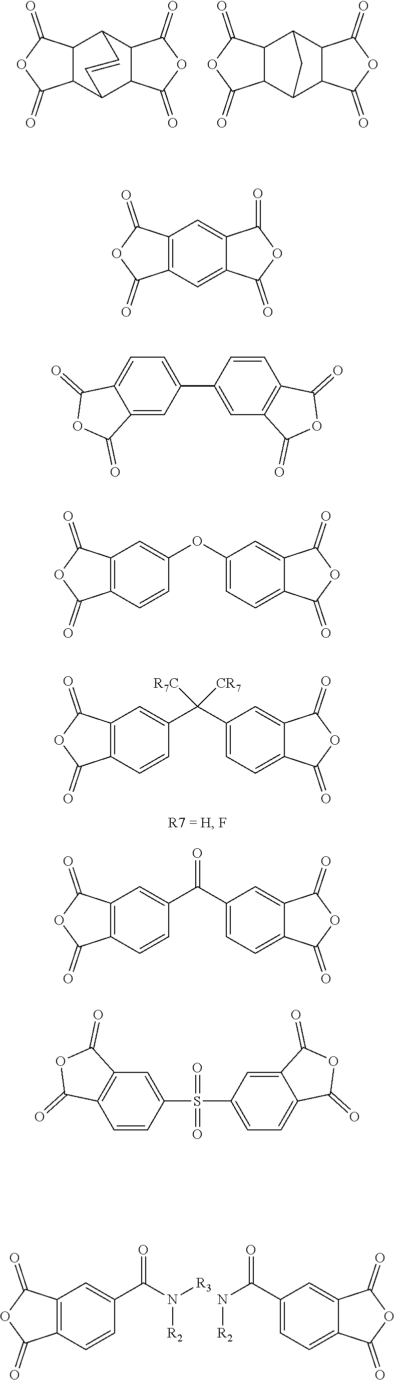

In some embodiments of the curable precursor disclosed herein, the bis-maleimide which is used for the reaction to make the maleimide-terminated polyamide-imide polymer is derived from a dimer diamine, preferably from a C-36 dimer diamine, and the amine-terminated polyamide which is used for the reaction to make the maleimide-terminated polyamide-imide polymer is a polyamide derived from a dimer acid, preferably from a C-36 dimer acid, i.e. the amine-terminated polyamide is a polyamide for which a dimer acid has been used as dicarboxylic acid for the reaction to from the amine-terminated polyamide, preferably a C-36 dimer acid.

The use of C-36 based maleimides and C-36 based polyamides for the reaction to form the maleimide-terminated polyamide-imide polymer results in good compatibility of the reaction components in the reaction melt. Furthermore, highly hydrophobic adhesives are obtained by using C-36 based maleimides and C-36 based polyamides.

The molar ratio of the diamine (i) to the compound (ii) in the reaction to form the amine-terminated polyamide may be from 1.01/1.00 to 2.0/1.00.

The weight average molecular weight (Mw) of the maleimide-terminated polyamide-imide polymer of the curable precursor disclosed herein typically is from 10⁴ to 10⁶ g/mol.

The weight average molecular weight (Mw) of the maleimide-terminated polyamide-imide polymer may be determined by conventional gel permeation chromatography (GPC) using appropriate techniques well known to those skilled in the art.

In some embodiments, the curable precursor disclosed herein comprises a first and a second maleimide-terminated polyamide-imide polymer according to formula (6). The first maleimide-terminated polyamide-imide polymer has a lower molecular weight than the second maleimide-terminated polyamide-imide polymer.

The weight average molecular weight (Mw) of the second maleimide-terminated polyamide-imide polymer may be at least 15,000 g/mol higher than the weight average molecular weight (Mw) of the first maleimide-terminated polyamide-imide polymer.

The weight average molecular weight (Mw) of the second maleimide-terminated polyamide-imide polymer may be at most 100,000 g/mol higher than the weight average molecular weight (Mw) of the first maleimide-terminated polyamide-imide polymer.

The weight average molecular weight (Mw) of the second maleimide-terminated polyamide-imide polymer may be at least 15,000 g/mol and at most 100,000 g/mol higher than the weight average molecular weight (Mw) of the first maleimide-terminated polyamide-imide polymer.

The adhesive properties such as adhesive strength of a curable precursor comprising a first and second maleimide-terminated polyamide-imide polymer may be substantially different from a curable precursor comprising only a first maleimide-terminated polyamide-imide polymer with a certain weight average molecular weight (Mw).

Further disclosed herein is an adhesive composition comprising a cured adhesive, wherein the cured adhesive is the reaction product of the curable precursor as disclosed herein.

The adhesive composition may comprise a cross-linked maleimide-terminated polyamide-imide polymer according to formula (7)

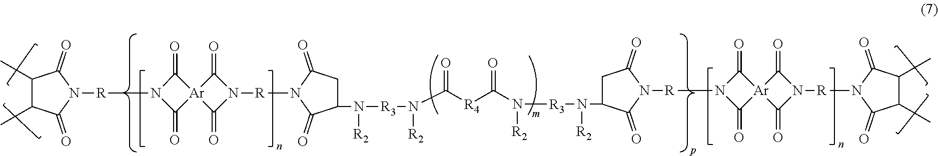

wherein
n is an integer from 0 to 10;
m is an integer from 1 to 15, preferably from 1 to 5;
p is an integer from 1 to 20;
R is an aliphatic or aromatic moiety;
Ar is a tetravalent aromatic moiety;
R₃ is an alkylene, branched alkylene, cycloalkylene, substituted or unsubstituted arylene, heteroalkylene, heterocycloalkylene, or silicone group;
R₄ is an aliphatic or aromatic moiety;
and for each —R₂N—R₃—NR₂— unit in formula (6)
   (i) each of the two R₂ groups, independently, is hydrogen or a linear or branched alkyl, cycloalkyl, aryl, heteroalkyl, or heteroaryl moiety, or
   (ii) the two R₂ groups are alkylene or branched alkylene and form a heterocyclic compound.

The square brackets at the open bonds of the terminal maleimide groups of formula (7) indicate covalent bonds to another polymer according to formula (7), which have been obtained as a result of the crosslinking.

In formula (7), R is an aliphatic or aromatic moiety, as described above in more detail for formula (6). In formula (7), Ar is a tetravalent aromatic moiety.

In formula (7), the group R₃ is an alkylene, branched alkylene, cycloalkylene, substituted or unsubstituted arylene, heteroalkylene, heterocycloalkylene, or silicone group. The alkylene, branched alkylene, cycloalkylene, substituted and unsubstituted arylene, heteroalkylene, heterocycloalkylene, and silicone group and examples thereof are as described above in more detail for formula (6).

In formula (7), the group R₄ is an aliphatic or aromatic moiety. The aliphatic and aromatic moiety is as described above in more detail for formula (6).

For each —R₂N—R₃—NR₂— unit in formula (7)
(i) each R₂ group, independently, is hydrogen or a linear or branched alkyl, cycloalkyl, aryl, heteroalkyl, or heteroaryl moiety, or
(ii) the two R₂ groups are linear or branched alkyl and form a heterocyclic compound.

The linear or branched alkyl, cycloalkyl, aryl, heteroalkyl, heteroaryl moiety, and heterocyclic compound of the R₂ group in formula (7) are as described above in more detail for formula (6).

In some embodiments, the two R₂ groups of one or more individual —R₂N—R₃—NR₂— units in formula (7) are both hydrogen. Preferably, the two R₂ groups of the individual —R₂N—R₃—NR₂— units are both a linear or branched alkyl group, or the two R₂ groups of the individual —R₂N—R₃—NR₂— units are both an alkylene or a branched alkylene group and form a heterocyclic compound. Combinations of these two are also possible, i.e. the two R₂ groups of some of the individual —R₂N—R₃—NR₂— units may be both a linear or branched alkyl group, and the two R₂ groups of some other the individual —R₂N—R₃—NR₂— units may be both an alkylene or a branched alkylene group and form a heterocyclic compound.

In some embodiments, the adhesive composition disclosed herein is in the form of an adhesive tape.

Further disclosed herein is a process for making a curable precursor of an adhesive composition according to the present disclosure, the process comprising reacting an amine-terminated polyamide with a bis-maleimide by a poly-Michael-Addition.

By the poly-Michael-Addition, an amine-terminated polyamide and a bis-maleimide are reacted to form a maleimide-terminated polyamide-imide polymer which may be according to formula (6).

The amine-terminated polyamide and the bis-maleimide that are used for the poly-Michael-Addition reaction to form the maleimide-terminated polyamide-imide polymer are as described above more in detail for the curable precursor.

The ratio of active amine equivalents to active maleimide equivalents in the poly-Michael-Addition may be from 0.2 to 0.95.

The process for making a curable precursor of an adhesive composition as disclosed herein may further comprise a chain extension of the amine-terminated polyamide by reacting the amine-terminated polyamide with a compound selected from the group consisting of dicarboxylic acids and dicarboxylic acid derivatives. Examples for dicarboxylic acid derivatives are dicarboxylic acid anhydrides and dicarboxylic acid chloride esters. The chain extension is carried out before the poly-Michael-Addition.

The chain extension may be carried out by a condensation reaction according to the general reaction scheme (A)

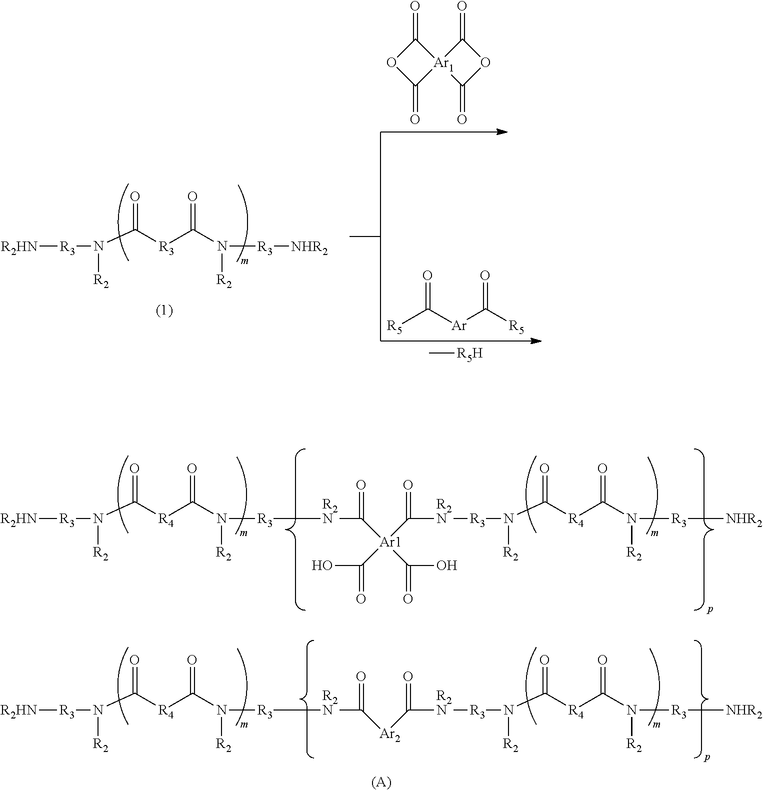

In reaction scheme (A),
m is an integer from 1 to 15, preferably from 1 to 5;
R₃ is an alkylene, branched alkylene, cycloalkylene, substituted or unsubstituted arylene, heteroalkylene, heterocycloalkylene, or silicone group;
R₄ is an aliphatic or aromatic moiety;
and for each —R₂N—R₃—NR₂ unit in formula (1)
   (i) each R₂ group, independently, is hydrogen or a linear or branched alkyl, cycloalkyl, aryl, heteroalkyl, or heteroaryl moiety, or
   (ii) the two R₂ groups are linear or branched alkyl and form a heterocyclic compound.

For the upper condensation reaction of reaction scheme (A), a dicarboxylic acid anhydride is used for chain extension. For the lower condensation reaction of reaction scheme (A), a dicarboxylic acid equivalent is used for chain extension. The reaction product of the chain extension according to reaction scheme (A) is a chain-extended amine-capped polyamide.

By chain extension, the compatibility of the amine-capped polyamide with the bis-maleimide with which the amine-capped polyamide obtained by chain extension is subsequently reacted can be improved. Chain extension also can be used to alter the tack of the subsequent maleimide-capped polyamide-imide and hence to control adhesion. Furthermore, if a dicarboxylic acid anhydride is used for chain extension, the pendant acid groups formed in the chain-extended amine-capped polyamide can render the maleimide-terminated polyamide-imide polymer according to formula (6) base soluble which makes it suitable for use as a negative tone photo-imageable polymer.

The process for making a curable precursor of an adhesive composition as disclosed herein may further comprise crosslinking of the maleimide-terminated polyamide-imide polymer to form a crosslinked polymer.

In the process for making a curable precursor of an adhesive composition according to the present disclosure, the maleimide-terminated polyamide-imide polymer may be according to formula (6)

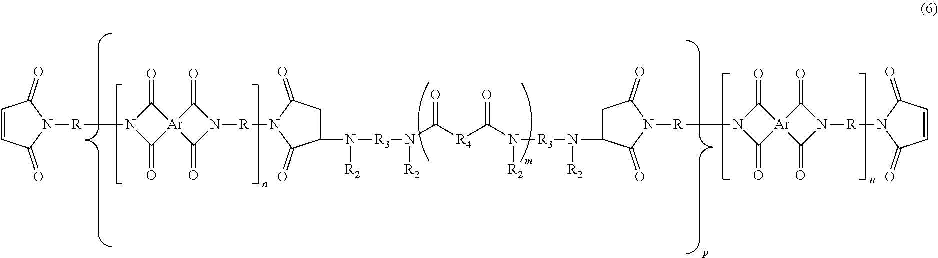

and the crosslinked polymer may be according to formula (7)

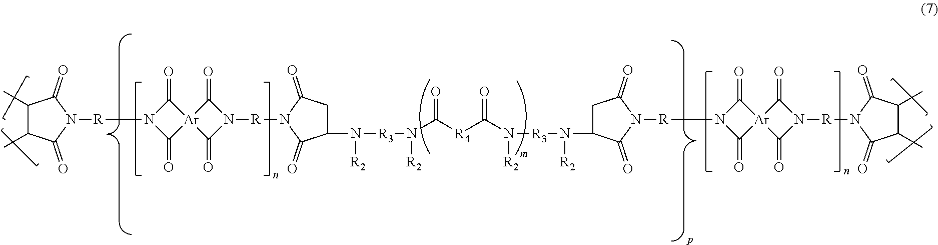

In formulas (6) and (7),
n is an integer from 0 to 10;
m is an integer from 1 to 15, preferably from 1 to 5;
p is an integer from 1 to 20;
R is an aliphatic or aromatic moiety;
Ar is a tetravalent aromatic moiety;
R₃ is an alkylene, branched alkylene, cycloalkylene, substituted or unsubstituted arylene, heteroalkylene, heterocycloalkylene, or silicone group;
R₄ is an aliphatic or aromatic moiety;
and for each —R₂N—R₃—NR₂— unit in formulas (6) and (7)
   (i) each of the two R₂ groups, independently, is hydrogen or a linear or branched alkyl, cycloalkyl, aryl, heteroalkyl, or heteroaryl moiety, or
   (ii) the two R₂ groups are alkylene or branched alkylene and form a heterocyclic compound.

The square brackets at the open bonds of the terminal maleimide groups of formula (7) indicate covalent bonds to another polymer according to formula (7), which have been obtained as a result of the crosslinking.

In formulas (6) and (7), R is an aliphatic or aromatic moiety, as described above in more detail for the maleimide-terminated polyamide-imide polymer. In formulas (6) and (7), Ar is a tetravalent aromatic moiety.

In formulas (6) and (7), the group R₃ is an alkylene, branched alkylene, cycloalkylene, substituted or unsubstituted arylene, heteroalkylene, heterocycloalkylene, or silicone group. The alkylene, branched alkylene, cycloalkylene, substituted and unsubstituted arylene, heteroalkylene, heterocycloalkylene, and silicone group and examples thereof are as described above in more detail for the maleimide-terminated polyamide-imide polymer.

In formulas (6) and (7), the group R₄ is an aliphatic or aromatic moiety. The aliphatic and aromatic moiety is as described above in more detail for the maleimide-terminated polyamide-imide polymer.

For each —R₂N—R₃—NR₂— unit in formulas (6) and (7)
(i) each R₂ group, independently, is hydrogen or a linear or branched alkyl, cycloalkyl, aryl, heteroalkyl, or heteroaryl moiety, or
(ii) the two R₂ groups are linear or branched alkyl and form a heterocyclic compound.

The linear or branched alkyl, cycloalkyl, aryl, heteroalkyl, heteroaryl moiety, and heterocyclic compound of the R₂ group in formula (7) are as described above in more detail for the maleimide-terminated polyamide-imide polymer.

In some embodiments, the two R₂ groups of one or more individual —R₂N—R₃—NR₂— units in formulas (6) and (7) are both hydrogen. Preferably, the two R₂ groups of the individual —R₂N—R₃—NR₂— units are both a linear or branched alkyl group, or the two R₂ groups of the individual —R₂N—R₃—NR₂— units are both an alkylene or a branched alkylene group and form a heterocyclic compound. Combinations of these two are also possible, i.e. the two R₂ groups of some of the individual —R₂N—R₃—NR₂— units may be both a linear or branched alkyl group, and the two R₂ groups of some other the individual —R₂N—R₃—NR₂— units may be both an alkylene or a branched alkylene group and form a heterocyclic compound.

Crosslinking of the maleimide-terminated polyamide-imide polymer may be carried out using UV light.

Crosslinking may be carried out at a temperature below 50° C., or at a temperature of at most 40° C., or at most 30° C., or at room temperature (23° C.). Preferably, curing is carried out at room temperature (23° C.).

The process for making the curable precursor of an adhesive composition according to the present disclosure may comprise forming of an adhesive tape. For the forming of the adhesive tape, the curable precursor as disclosed herein may be dissolved in a solvent, the dissolved curable precursor may be coated on a backing, the curable precursor may be UV cured to form the adhesive composition coated on the backing, and a protective temporary layer may be applied on the adhesive composition for transportation to the final use location. When the tape is used, the protective temporary layer is removed.

Further disclosed herein is an article comprising a first substrate, a second substrate and an adhesive composition disposed between and adhering to the first substrate and the second substrate, wherein the adhesive composition is according to the present disclosure.

Further disclosed herein is an article comprising an adhesive composition according to the present disclosure, a first substrate and a cover film, wherein the adhesive composition is disposed between and adhering to the first substrate and the cover film, and wherein the adhesion to the cover film is lower than the adhesion to the first substrate, and wherein the cover film is a temporary protective layer.

The adhesion to the cover film is substantially low allowing it to serve as a temporary protective layer. During the use of the article, the cover film is removed, and the adhesive composition is adhered permanently to a second substrate. The first substrate may be a polyimide film, and the cover film may be made from a material comprising polyethylene terephthalate (PET). The cover film comprises a release coating contacting the adhesive composition.

Further disclosed herein is a method of use of an adhesive composition according to the present disclosure, comprising
disposing the adhesive composition between a first substrate and a second substrate and adhering the first substrate to the second substrate by the adhesive composition, wherein the second substrate comprises a plurality of individual elements;
conducting one or more process steps on the individual elements, wherein the plurality of individual elements is combined by the one or more process steps; and
removing the first substrate and the adhesive composition from the second substrate.

The one or more process steps that are carried out on the individual elements may be process steps such as encapsulation, wiring and the like. Typically, the adhesive composition is in the form of a tape.

Further disclosed herein is a method of use of a curable precursor according to the present disclosure, the method comprising
disposing the curable precursor between a first substrate and a second substrate and contacting the first and the second substrate by the curable precursor;
curing the curable precursor to form an adhesive composition adhering the first substrate to the second substrate.

At least one of the first and second substrate may comprise a plurality of electrically conducting elements.

The curable precursor of an adhesive composition as disclosed herein, and the adhesive composition as disclosed herein, may be used as temporary bonding adhesive, for example for semiconductor packaging, for processes such as fan-out wafer level packaging (FOWLP) and fan-out panel-level packaging (FOPLP).
Item 1 is a curable precursor of an adhesive composition, the curable precursor comprising a maleimide-terminated polyamide-imide polymer.
Item 2 is a curable precursor according to item 1, wherein the maleimide-terminated polyamide-imide polymer is according to formula (6)

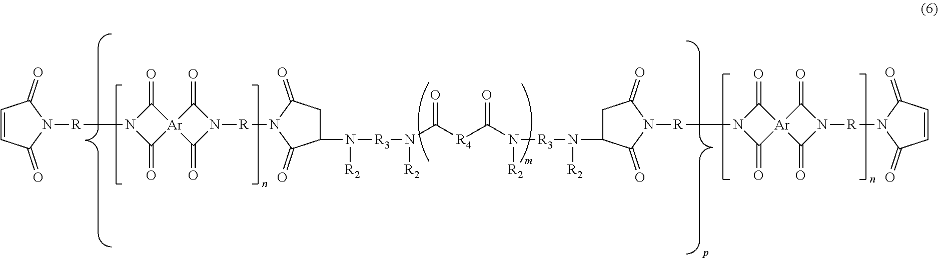

wherein
n is an integer from 0 to 10;
m is an integer from 1 to 15;
p is an integer from 1 to 20;
R is an aliphatic or aromatic moiety;
Ar is a tetravalent aromatic moiety;
R₃ is an alkylene, branched alkylene, cycloalkylene, substituted or unsubstituted arylene, heteroalkylene, heterocycloalkylene, or a covalent bond, or silicone group;
R₄ is an aliphatic or aromatic moiety;
and wherein for each —R₂N—R₃—NR₂— unit in formula (6)
   (i) each of the two R₂ groups, independently, is hydrogen or a linear or branched alkyl, cycloalkyl, aryl, heteroalkyl, or heteroaryl moiety, or
   (ii) the two R₂ groups are alkylene or branched alkylene and form a heterocyclic compound.
Item 3 is a curable precursor according to item 1 or 2, wherein the maleimide-terminated polyamide-imide polymer is a reaction product of (i) an amine-terminated polyamide and (ii) a bis-maleimide.
Item 4 is a curable precursor according to item 3, wherein the amine-terminated polyamide comprises tertiary amides in the backbone of the amine-terminated polyamide.
Item 5 is a curable precursor according to item 4, wherein tertiary amides are present in the amine-terminated polyamide in an amount of at least 50 mol %, based on the total amide content present in the backbone of the amine-terminated polyamide.
Item 6 is a curable precursor according to any of items 3 to 5, wherein the amine-terminated polyamide is according to formula (1)

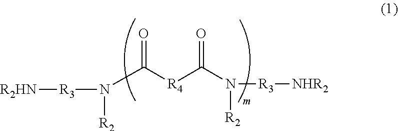

wherein
m is an integer from 1 to 15;
R₃ is an alkylene, branched alkylene, cycloalkylene, substituted or unsubstituted arylene, heteroalkylene, heterocycloalkylene, or silicone group;
R₄ is an aliphatic or aromatic moiety;
and wherein for each —R₂N—R₃—NR₂ unit in formula (1)
   (i) each of the two R₂ groups, independently, is hydrogen or a linear or branched alkyl, cycloalkyl, aryl, heteroalkyl, or heteroaryl moiety, or
   (ii) the two R₂ groups are linear or branched alkyl and form a heterocyclic compound.
Item 7 is a curable precursor according to any of items 3 to 6, wherein the bis-maleimide is according to formula (5)

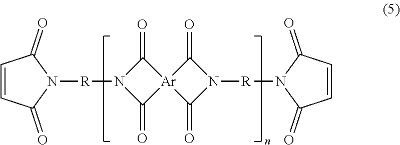

wherein
n is an integer from 0 to 10;
R is an aliphatic or aromatic moiety; and
Ar is a tetravalent aromatic moiety.
Item 8 is a curable precursor according to any of items 3 to 7, wherein the bis-maleimide comprises an aromatic bis-maleimide, or a bis-maleimide derived from a dimer diamine, preferably from a C-36 dimer diamine, or a combination thereof.
Item 9 is a curable precursor according to any of items 3 to 8, wherein the amine-terminated polyamide is a reaction product of (i) a diamine, and (ii) a compound selected from the group consisting of dicarboxylic acids, dicarboxylic acid derivatives, and combinations thereof.
Item 10 is a curable precursor according to item 9, wherein the diamine is selected from the group consisting of secondary diamines, secondary/primary hybrid diamines, and mixtures thereof.
Item 11 is a curable precursor according to item 9 or 10, wherein the diamine has a formula R₂—NH—R₃—NH—R₂, wherein the R₃ group is an alkylene or branched alkylene group, cycloalkylene group, substituted or unsubstituted arylene group, heteroalkylene group, heterocycloalkylene group, or silicone group,
and wherein
   (i) each R₂ group, independently, is a linear or branched alkyl group, cycloalkyl group, aryl group, heteroalkyl group, heteroaryl group, or hydrogen atom, or
   (ii) the R₂ groups are linear or branched alkyl and form a heterocyclic compound.
Item 12 is a curable precursor according to any of items 9 to 11, wherein the diamine comprises piperazine (2)

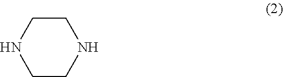

or 1,3-di(piperidin-4-yl)propane (3)

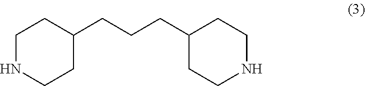 [SMILES: C(CC1CCNCC1)CC1CCNCC1]

or combinations thereof.
Item 13 is a curable precursor according to any of items 9 to 12, wherein the diamine comprises a secondary amine-terminated silicone in an amount of up to 30 mol %, based on the total amount of diamines which are used for the reaction to make the amine-terminated polyamide, and wherein the secondary amine-terminated silicone is according to formula (4)

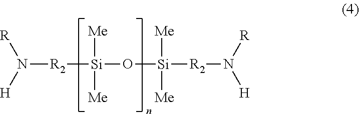

wherein
n is an integer from 5-40;
R is a C1-C6 linear or branched alkyl group;
R₂ is a C3 alkyl or substituted alkyl group;
Me is a methyl or phenyl group.
Item 14 is a curable precursor according to any of items 9 to 13, wherein the diamine is free of aryl moiety.
Item 15 is a curable precursor according to any of items 9 to 14, wherein the dicarboxylic acid is a dimer acid.
Item 16 is a curable precursor according to any of items 3 to 15, wherein the bis-maleimide is derived from a dimer diamine, preferably from a C-36 dimer diamine, and wherein the amine-terminated polyamide is a polyamide derived from a dimer acid, preferably from a C-36 dimer acid.
Item 17 is a curable precursor according to any of items 9 to 16, wherein the molar ratio of the diamine (i) to the compound (ii) is from 1.01/1.00 to 2.0/1.00.
Item 18 is a curable precursor according to any of items 1 to 17, wherein the maleimide-terminated polyamide-imide polymer has a weight average molecular weight (Mw) of from 10⁴ to 10⁶ g/mol.
Item 19 is a curable precursor according to any of items 1 to 18, comprising a first and a second maleimide-terminated polyamide-imide polymer according to formula (6), wherein the first maleimide-terminated polyamide-imide polymer has a lower molecular weight than the second maleimide-terminated polyamide-imide polymer.
Item 20 is an adhesive composition comprising a cured adhesive, wherein the cured adhesive is the reaction product of the curable precursor according to any of items 1 to 19.
Item 21 is an adhesive composition according to item 20, comprising a cross-linked maleimide-terminated polyamide-imide polymer according to formula (7)

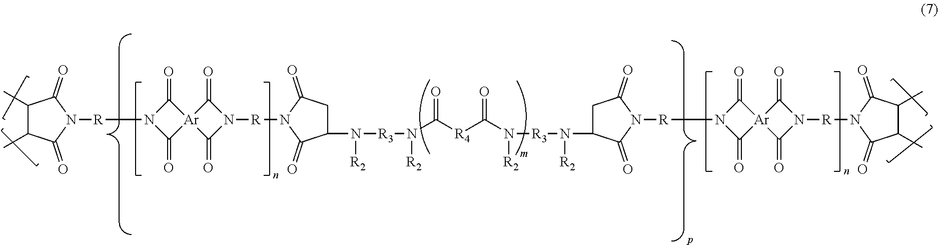

wherein
n is an integer from 0 to 10;
m is an integer from 1 to 15;
p is an integer from 1 to 20;
R is an aliphatic or aromatic moiety;
Ar is a tetravalent aromatic moiety;
R₃ is an alkylene, branched alkylene, cycloalkylene, substituted or unsubstituted arylene, heteroalkylene, heterocycloalkylene, or silicone group;
R₄ is an aliphatic or aromatic moiety;
and for each —R₂N—R₃—NR₂— unit in formula (6)
   (i) each of the two R₂ groups, independently, is hydrogen or a linear or branched alkyl, cycloalkyl, aryl, heteroalkyl, or heteroaryl moiety, or
   (ii) the two R₂ groups are alkylene or branched alkylene and form a heterocyclic compound.
Item 22 is an adhesive composition according to item 20 or 21, wherein the adhesive composition is in the form of an adhesive tape.
Item 23 is a process for making a curable precursor of an adhesive composition according to any of items 1 to 19, the process comprising reacting an amine-terminated polyamide with a bis-maleimide by a poly-Michael-Addition.
Item 24 is a process according to item 23, wherein the ratio of active amine equivalents to active maleimide equivalents is from 0.2 to 0.95.
Item 25 is a process according to item 23 or 24, further comprising a chain extension of the amine-terminated polyamide by reacting the amine-terminated polyamide with a compound selected from the group consisting of dicarboxylic acids and dicarboxylic acid derivatives, wherein the chain extension is carried out before the poly-Michael-Addition.
Item 26 is a process according to any of items 23 to 25, further comprising crosslinking of the maleimide-terminated polyamide-imide polymer to form a crosslinked polymer.
Item 27 is a process according to item 26, wherein the maleimide-terminated polyamide-imide polymer is according to formula (6)

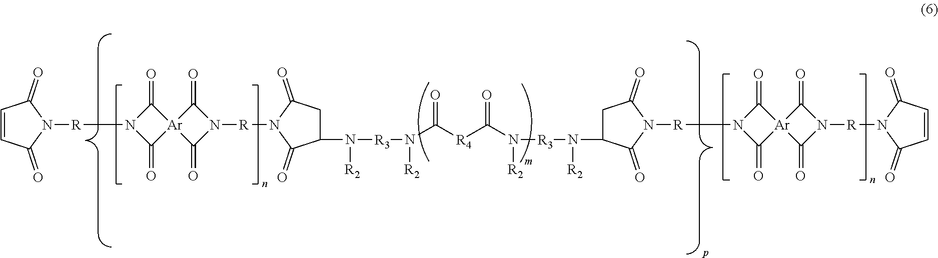

and wherein the crosslinked polymer is according to formula (7)

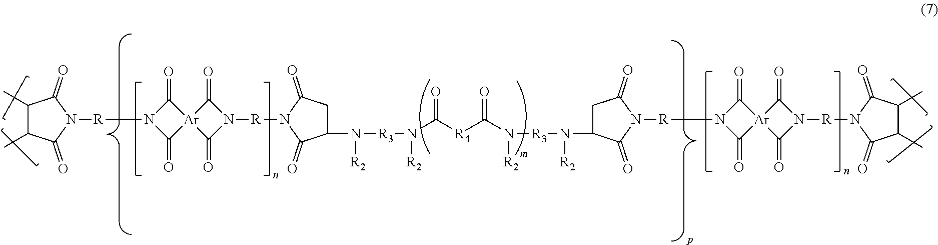

wherein
n is an integer from 0 to 10;
m is an integer from 1 to 15;
p is an integer from 1 to 20;
R is an aliphatic or aromatic moiety;
Ar is a tetravalent aromatic moiety;
R₃ is an alkylene, branched alkylene, cycloalkylene, substituted or unsubstituted arylene, heteroalkylene, heterocycloalkylene, or silicone group;
R₄ is an aliphatic or aromatic moiety;
and for each —R₂N—R₃—NR₂— unit in formulas (6) and (7)
   (i) each of the two R₂ groups, independently, is hydrogen or a linear or branched alkyl, cycloalkyl, aryl, heteroalkyl, or heteroaryl moiety, or
   (ii) the two R₂ groups are alkylene or branched alkylene and form a heterocyclic compound.
Item 28 is an article comprising a first substrate, a second substrate and an adhesive composition disposed between and adhering to the first substrate and the second substrate, wherein the adhesive composition is according to any of items 20 to 22.
Item 29 is an article comprising an adhesive composition according to any of items 20 to 22, a first substrate and a cover film, wherein the adhesive composition is disposed between and adhering to the first substrate and the cover film, and wherein the adhesion to the cover film is lower than the adhesion to the first substrate, and wherein the cover film is a temporary protective layer.
Item 30 is an article according to item 29, wherein the first substrate is a polyimide film, and wherein the cover film is made from a material comprising polyethylene terephthalate (PET), and wherein the cover film comprises a release coating contacting the adhesive composition.
Item 31 is a method of use of an adhesive composition according to any of items 20 to 22, comprising
   disposing the adhesive composition between a first substrate and a second substrate and adhering the first substrate to the second substrate by the adhesive composition, wherein the second substrate comprises a plurality of individual elements;
   conducting one or more process steps on the individual elements, wherein the plurality of individual elements is combined by the one or more process steps; and
   removing the first substrate and the adhesive composition from the second substrate.
Item 32 is a method of use of a curable precursor according to any of items 1 to 19, the method comprising
   disposing the curable precursor between a first substrate and a second substrate and contacting the first and the second substrate by the curable precursor;
   curing the curable precursor to form an adhesive composition adhering the first substrate to the second substrate.
Item 33 is a method according to item 32, wherein at least one of the first and second substrate comprises a plurality of electrically conducting elements.

1. A curable precursor of an adhesive composition, the curable precursor comprising a maleimide-terminated polyamide-imide polymer.

2. The curable precursor of claim 1, wherein the maleimide-terminated polyamide-imide polymer is according to formula (6) 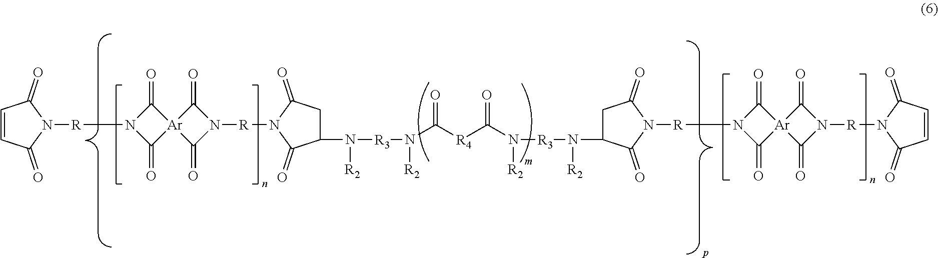
wherein
n is an integer from 0 to 10;
m is an integer from 1 to 15;
p is an integer from 1 to 20;
R is an aliphatic or aromatic moiety;
Ar is a tetravalent aromatic moiety;
R₃ is an alkylene, branched alkylene, cycloalkylene, substituted or unsubstituted arylene, heteroalkylene, heterocycloalkylene, or a covalent bond, or silicone group;
R₄ is an aliphatic or aromatic moiety;
and wherein for each —R₂N—R₃—NR₂— unit in formula (6)
(i) each of the two R₂ groups, independently, is hydrogen or a linear or branched alkyl, cycloalkyl, aryl, heteroalkyl, or heteroaryl moiety, or
(ii) the two R₂ groups are alkylene or branched alkylene and form a heterocyclic compound.

3. The curable precursor of claim 1, wherein the maleimide-terminated polyamide-imide polymer is a reaction product of (i) an amine-terminated polyamide and (ii) a bis-maleimide.

4. The curable precursor of claim 3, wherein the amine-terminated polyamide is according to formula (1) 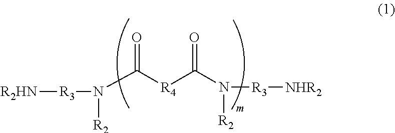
wherein
m is an integer from 1 to 15;
R₃ is an alkylene, branched alkylene, cycloalkylene, substituted or unsubstituted arylene, heteroalkylene, heterocycloalkylene, or silicone group;
R₄ is an aliphatic or aromatic moiety;
and wherein for each —R₂N—R₃—NR₂ unit in formula (1)
(i) each of the two R₂ groups, independently, is hydrogen or a linear or branched alkyl, cycloalkyl, aryl, heteroalkyl, or heteroaryl moiety, or
(ii) the two R₂ groups are linear or branched alkyl and form a heterocyclic compound.

5. The curable precursor of claim 3, wherein the bis-maleimide is according to formula (5) 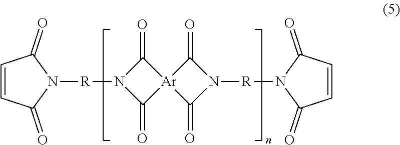
wherein
n is an integer from 0 to 10;
R is an aliphatic or aromatic moiety; and
Ar is a tetravalent aromatic moiety.

6. The curable precursor of claim 3, wherein the amine-terminated polyamide is a reaction product of (i) a diamine, and (ii) a compound selected from the group consisting of dicarboxylic acids, dicarboxylic acid derivatives, and combinations thereof.

7. The curable precursor of claim 6, wherein the diamine has a formula R₂—NH—R₃—NH—R₂, wherein the R₃ group is an alkylene or branched alkylene group, cycloalkylene group, substituted or unsubstituted arylene group, heteroalkylene group, heterocycloalkylene group, or silicone group,
and wherein
(iii) each R₂ group, independently, is a linear or branched alkyl group, cycloalkyl group, aryl group, heteroalkyl group, heteroaryl group, or hydrogen atom, or
(iv) the R₂ groups are linear or branched alkyl and form a heterocyclic compound.

8. The curable precursor of claim 1, comprising a first and a second maleimide-terminated polyamide-imide polymer according to formula (6), wherein the first maleimide-terminated polyamide-imide polymer has a lower molecular weight than the second maleimide-terminated polyamide-imide polymer.

9. An adhesive composition comprising a cured adhesive, wherein the cured adhesive is the reaction product of the curable precursor according to claim 1.

10. The adhesive composition of claim 9, comprising a cross-linked maleimide-terminated polyamide-imide polymer according to formula (7) 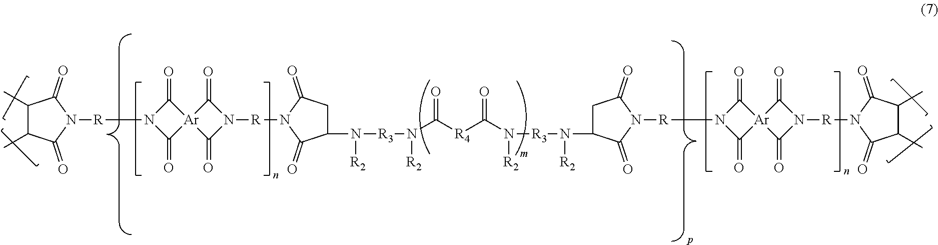
wherein
n is an integer from 0 to 10;
m is an integer from 1 to 15;
p is an integer from 1 to 20;
R is an aliphatic or aromatic moiety;
Ar is a tetravalent aromatic moiety;
R₃ is an alkylene, branched alkylene, cycloalkylene, substituted or unsubstituted arylene, heteroalkylene, heterocycloalkylene, or silicone group;
R₄ is an aliphatic or aromatic moiety;
and for each —R₂N—R₃—NR₂— unit in formula (6)
(i) each of the two R₂ groups, independently, is hydrogen or a linear or branched alkyl, cycloalkyl, aryl, heteroalkyl, or heteroaryl moiety, or
(ii) the two R₂ groups are alkylene or branched alkylene and form a heterocyclic compound.
